(19) United States
(12) Patent Application Publication
(10) Pub. No.: US 2011/0320829 A1
(43) Pub. Date: Dec. 29, 2011

(54) Power Supply Device Having USB Port with Large Current

(75) Inventor: Cheng Huang Chan, Chung Ho City (TW)

(73) Assignee: A-DATA TECHNOLOGY (SUZHOU) CO., LTD., SuZhou (CN)

(21) Appl. No.: 12/909,779

(22) Filed: Oct. 21, 2010

(30) Foreign Application Priority Data
Jun. 24, 2010 (CN) 201010208051.5

(51) Int. Cl. G06F 1/26

(52) U.S. Cl. 713/300

(57) ABSTRACT

A power supply device is mounted in a computer system. The power supply device includes a shield defining an opening, a USB port received in the opening to be exposed to an exterior, and a power supply module residing in the shield to provide power for both the computer system and the USB port. The USB port is coupled to the power supply module and provides charging current up to 2000 mA to meet the demand of external electronic devices.

### BACKGROUND OF THE INVENTION

1. Field of the Invention

The present invention relates to a power supply device, and more particularly to a power supply device having USB port with large current suitable for battery charging of external devices.

2. Description of Related Art

Universal Serial Bus (USB) is the one of the most popular connecting port for connecting external electronic devices and computer systems, because of its advantages of single connection, automatic software detection and hot plug etc. Other devices, such as MP3, mobile phones and PDAs even use USB ports of the computer systems for battery charging or to obtain working power of such devices.

With the electronic devices becoming more and more powerful, the current requirement of the electronic devices is larger and larger, accordingly. However, a standard USB port of the traditional computer system is capable of providing current up to 500 mA. Under this condition, if the external electronic devices need over 500 mA for battery charging, the traditional USB port cannot be competent for the job. For example, the external HDD is one of such external electronic devices. With the storage capacity of the external HDD becoming larger and larger, the requirement of working current of the external HDD is enhanced, accordingly. The traditional USB port can not provide such big current. Under this condition, an AC adaptor is needed to improve the output current so that the external HDD can work. Furthermore, iPhone and iPad are two hot products of Apple Inc. However, these products need big working current among which the working current of iPhone reaches 800 mA, and the working current of iPad reaches up to 1700 mA. It is obvious that the USB port of the traditional computer systems can not meet these demands.

Thereafter, two technologies, “On/Off Charge” and “3X USB Power” are developed, among which the “On/Off Charge” technology can provide the USB port suitable for battery charging even if the mother board of the computer system is sleeping or shut down. The “3X USB Power” technology mainly improves the power supply conditions of the USB port by widening the circuit from the power to the USB port, providing independent fuse of each USB port, and enhancing the threshold current of the fuses etc. As a result, the maximal current provided by the USB port reaches up to 1500 mA by using the “3X USB Power” technology.

However, both the “On/Off Charge” technology and the “3X USB Power” technology are new technologies related to a mother board of the computer system. That is to say, in order to provide the USB port a large battery charging current, the original mother board must be replaced by a new mother board using the above-mentioned technologies, which may be unacceptable by the end users.

Hence, an improved power supply device having USB port with large current is desired.

### BRIEF SUMMARY OF THE INVENTION

The present invention provides a power supply device for being mounted in a computer system. The power supply device comprises a shield defining an opening, a USB port received in the opening to be exposed to an exterior, and a power supply module residing in the shield to provide power for both the computer system and the USB port. The USB port is coupled to the power supply module so that an external device can be charged up to 2000 mA, from the power supply module via the USB port.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a schematic diagram showing a power supply device mounted in a computer system in accordance with an embodiment of the present invention;

FIG. 2 is a perspective view of the power supply device as shown in FIG. 1; and

FIG. 3 is a schematic diagram showing a power supply module of the power supply device.

### DETAILED DESCRIPTION OF THE PREFERRED EMBODIMENTS

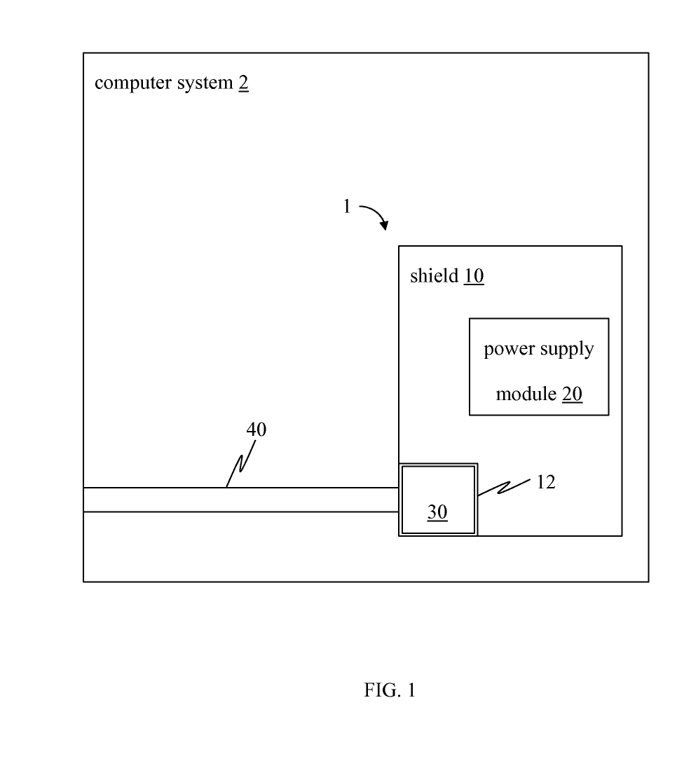

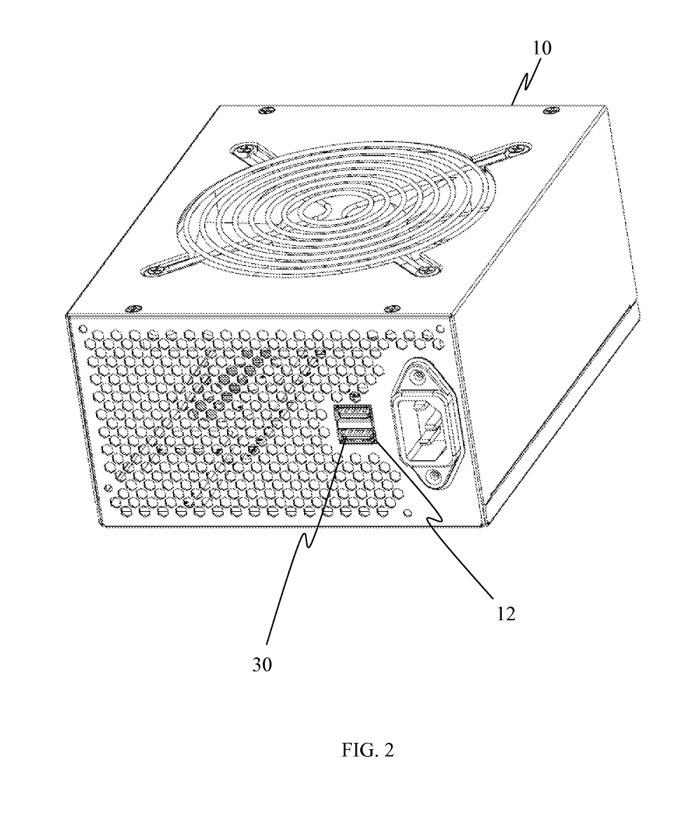

Reference will now be made to the drawing figures to describe the preferred embodiment of the present invention in detail. FIGS. 1 and 2 illustrate a power supply device 1 including a shield 10, a power supply module 20 residing in the shield 10 and a USB port 30.

Referring to FIG. 1, the power supply device 1 is mounted in a computer system 2 for providing suitable power so that the computer system 2 can work normally. According to the preferred embodiment of the present invention, the power supply device 1 is compatible to Advanced Technology Extended (ATX) specifications which are the most common standards in the power supply device.

The power supply device 1 defines at least one opening 12 formed in at least one peripheral surface thereof for mounting the USB port 30. The power supply module 20 is adapted for providing power of the computer system 2 and the USB port 30. The USB port 30 is coupled to the power supply module 20 so that external devices, such as MP3, mobile phones, PDAs etc. can be charged from the power supply module 20 via the USB port 30. Referring to FIG. 2, the USB port 30 is exposed to an exterior so that external devices can be facilitated to be inserted into the USB port 30 for charging.

The traditional power supply devices provide up to 2000 mA while the current provided for the USB port is only up to 500 mA, which is not suitable for a trend that the external devices require larger and larger charging current. However, the power supply device 1 according to the preferred embodiment of the present invention provides the USB port 30 up to 2000 mA charging current to meet the demands of the external devices.

The USB port 30 is directly connected with the power supply module 20 of the power supply device 1 so that the USB port 30 can always be used for charging the external devices even if the computer system 2 is sleeping or shut down. In traditional designs, in order to achieve the above-mentioned advantage, an additional power cable is needed to connect between the power supply device and the USB port. However, according to the preferred embodiment of the present invention, the additional power cable can be omitted in the power supply device 1 for saving cost. Besides, when the computer system 2 is only used for charging the external devices, the computer system 2 needn't be started. As a result, the power provided for the working of the computer system 2 can be saved.

Besides, the power supply device 1 further includes a data transmission cable 40 which has one end coupled to the USB port 30 and the other end coupled to the computer system 2. The external devices and the computer system 2 can interchange data via the data transmission cable 40. That is to say, the USB port 30 not only functions as a charging port but also functions as a data transmission medium for the external devices and the computer system 2.

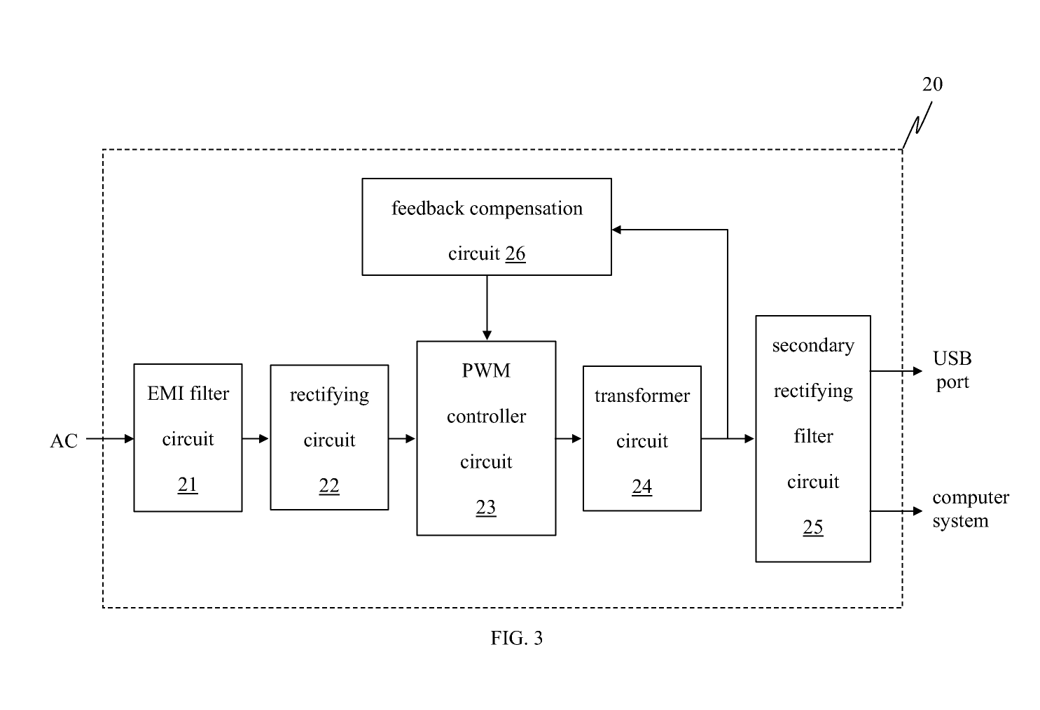

Referring to FIG. 3, the power supply module 20 includes an ElectroMagnetic Interference (EMI) filter circuit 21 for processing an external Alternating Current (AC), a rectifying circuit 22 for converting the AC into Direct Circuit (DC), a Pulse-Width Modulation (PWM) controller circuit 23 after the rectifying circuit 22, a transformer circuit 24 for optimizing the DC output by the PWM controller circuit 23, and a secondary rectifying filter circuit 25 after the transformer circuit 24 to stabilize the DC which is output to the USB port 30 and the computer system 2. The EMI filter circuit 21 restricts inrush current of the external AC (such as civil voltage, 110 V) and filtrates the EMI of the external AC as well. Then, the rectifying circuit 22 converts the AC into DC. The rectifying circuit 22 is a bridge rectifying circuit, but not limited thereto. The power supply module 20 further includes a feedback compensation circuit 26 which receives the DC output by the transformer circuit 24 and then sends a signal to the PWM controller circuit 23 to judge whether the DC output by the transformer circuit 24 is suitable.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A power supply device for being mounted in a computer system, the power supply device comprising:
a shield defining an opening exposed to an exterior;
a power supply module residing in the shield to provide power for the computer system; and
a USB port received in the opening of the shield, the USB port being coupled to the power supply module so that an external device can be charged from the power supply module via the USB port.

2. The power supply device as claimed in claim 1, wherein the USB port provides charging current up to 2000 mA.

3. The power supply device as claimed in claim 1, wherein the USB port is directly coupled to the power supply module so that the USB port can always be used for charging even if the computer system is sleeping or shut down.

4. The power supply device as claimed in claim 1, wherein the power supply device is compatible to Advanced Technology Extend (ATX) specifications.

5. The power supply device as claimed in claim 1, further comprising a data transmission cable with one end coupled to the USB port and the other end coupled to the computer system, whereby the external device and the computer system interchange data via the data transmission cable.

6. The power supply device as claimed in claim 1, wherein the power supply module comprises an ElectroMagnetic Interference (EMI) filter circuit for processing an external Alternating Current (AC), a rectifying circuit for converting the AC into Direct Circuit (DC), and a transformer circuit for adjusting the DC so as to be suitable for the USB port and the computer system.

7. The power supply device as claimed in claim 6, wherein the EMI filter circuit restricts inrush current of the external AC and filtrates the EMI of the external AC as well.

8. The power supply device as claimed in claim 6, wherein the power supply module further comprises a Pulse-Width Modulation (PWM) controller circuit between the rectifying circuit and the transformer circuit for optimizing the DC.

9. The power supply device as claimed in claim 8, wherein the power supply module further comprises a feedback compensation circuit which receives the DC output by the transformer circuit and then sends a signal to the PWM controller circuit to judge whether the DC output by the transformer circuit is suitable.

10. The power supply device as claimed in claim 6, wherein the power supply module further comprises a secondary rectifying filter circuit after the transformer circuit to stabilize the DC which is output to the USB port and the computer system, respectively.

11. A power supply device mounted in a computer system, the power supply device comprising:
a shield defining an opening;
a USB port received in the opening of the shield to be exposed to an exterior;
a power supply module residing in the shield to provide power for both the computer system and the USB port; wherein
the USB port is coupled to the power supply module so that an external device can be charged up to 2000 mA, from the power supply module via the USB port.

12. The power supply device as claimed in claim 11, wherein the USB port is coupled to the power supply module so that the USB port can always be used for charging even if the computer system is sleeping or shut down.

13. The power supply device as claimed in claim 11, wherein the power supply device is compatible to Advanced Technology Extend (ATX) specifications.

14. The power supply device as claimed in claim 11, further comprising a data transmission cable with one end coupled to the USB port and the other end coupled to the computer system, whereby the external device and the computer system interchange data via the data transmission cable.

15. The power supply device as claimed in claim 11, wherein the power supply module comprises an ElectroMagnetic Interference (EMI) filter circuit for processing an external Alternating Current (AC), a rectifying circuit for converting the AC into Direct Circuit (DC), and a transformer circuit for adjusting the DC so as to be suitable for the USB port and the computer system.

16. The power supply device as claimed in claim 15, wherein the EMI filter circuit restricts inrush current of the external AC and filtrates the EMI of the external AC as well.

17. The power supply device as claimed in claim 15, wherein the power supply module further comprises a Pulse-Width Modulation (PWM) controller circuit between the rectifying circuit and the transformer circuit for optimizing the DC.

18. The power supply device as claimed in claim 17, wherein the power supply module further comprises a feedback compensation circuit which receives the DC output by the transformer circuit and then sends a signal to the PWM controller circuit to judge whether the DC output by the transformer circuit is suitable.

19. The power supply device as claimed in claim 15, wherein the power supply module further comprises a secondary rectifying filter circuit after the transformer circuit to stabilize the DC which is output to the USB port and the computer system, respectively.

20. The power supply device as claimed in claim 15, wherein the rectifying circuit is a bridge rectifying circuit.
